(19) United States
(12) Patent Application Publication
(10) Pub. No.: US 2026/0305585 A1
(43) Pub. Date: Oct. 8, 2026

(54) ANIMAL TREATMENT

(71) Applicant: TidalX AI Inc., Mountain View, CA (US)

(72) Inventors: Derek Martin Herbert, Mountain View, CA (US); Ben Yair Raanan, Aptos, CA (US)

(21) Appl. No.: 19/267,253

(22) Filed: Jul. 11, 2025

Related U.S. Application Data
(60) Provisional application No. 63/784,587, filed on Apr. 7, 2025.

(51) Int. Cl. A01K 29/00

(52) U.S. Cl. CPC A01K 61/13

(57) ABSTRACT

Methods, systems, and apparatus, including computer programs encoded on computer storage media, for treatment of animals. One of the methods includes detecting, using a captured image of an animal, (i) one or more target areas on a body of the animal and (ii) one or more exclusion areas on the body of the animal; configuring a projection area that (i) allows light to project onto the one or more target areas and (ii) prevents light from projecting onto the one or more exclusion areas; and projecting, using the projection area, light onto the body of the animal.

### CROSS-REFERENCE TO RELATED APPLICATIONS

This application claims the benefit of U.S. Provisional Application No. 63/784,587, filed Apr. 7, 2025, the contents of which are incorporated by reference herein.

### TECHNICAL FIELD

This specification relates to detecting and treating animals, e.g., animals in aquaculture environments.

### BACKGROUND

When animals are raised for food production or other means, disease, parasites, and other unfortunate issues can harm animals. Treatment and mitigation techniques that are not specifically tailored to particular needs of animals can be ineffectual and wasteful of resources or, in some of the worse cases, increasing harm to the animals subjected to the treatment.

### SUMMARY

This specification describes technologies for improved treatment of animals using light projection. These technologies generally involve detecting an animal and configuring a projection area that includes a target area and/or an exclusion area. The projected light can help to remove ectoparasites, heal diseased tissue, or improve biological processes. The projection area can be configured to prevent light from harming sensitive areas of an animal, such as eyes or a head region.

In general, one innovative aspect of the subject matter described in this specification can be embodied in methods that include the actions of detecting, using a captured image of an animal, (i) one or more target areas on a body of the animal and (ii) one or more exclusion areas on the body of the animal; configuring a projection area that (i) allows light to project onto the one or more target areas and (ii) prevents light from projecting onto the one or more exclusion areas; and projecting, using the projection area, light onto the body of the animal. Other embodiments of this aspect include corresponding computer systems, apparatus, and computer programs recorded on one or more computer storage devices, each configured to perform the actions of the methods.

The foregoing and other embodiments can each optionally include one or more of the following features, alone or in combination. In particular, one embodiment includes all the following features in combination. Feature 1: The projection area comprises multiple points in two-or three-dimensional space. Feature 2: Configuring the projection area comprises: configuring an exclusion area of the projection area to extend beyond a detected exclusion area on the body of the animal. Feature 3: The one or more exclusion areas include a head or eye area of the animal. Feature 4: Actions include determining at least one of (i) a time or (ii) relative position of the animal for projecting the light onto the body of the animal; determining at least one of (i) the time or (ii) the relative position of the animal is satisfied; and in response to determining at least one of (i) the time or (ii) the relative position of the animal is satisfied, projecting the light onto the body of the animal. Feature 5: Actions include providing data indicating an environment of the animal to one or more machine learning models; and receiving output of the one or more machine learning models as at least one of (i) the time or (ii) the relative position of the animal for projecting the light onto the body of the animal. Feature 6: Providing the data indicating the environment of the animal to the one or more machine learning models comprises data indicating at least one of: (i) time of day, (ii) operation schedule, (iii) visual clarity of the environment, (iv) proximity to light projector, (v) size of animal, (vi) speed of animal, and (vii) animal type. Feature 7: Actions include generating a control signal to move a light projector to a position; and projecting the light onto the body of the animal after reaching the position. Feature 8: Configuring the projection area comprises: predicting a future location of the animal using at least the captured image of the animal; and translating at least one of the detected target areas and the exclusion areas using the predicted future location, wherein projecting the light onto the body of the animal comprises projecting the light using the translated areas based on the predicted future location. Feature 9: Actions include configuring the projection area for a predicted location of the animal at a future point in time; waiting a period of time until the future point in time; and projecting the light onto the body of the animal at the future point in time. Feature 10: The one or more target areas include one or more ectoparasites and projecting the light onto the body of the animal comprises: projecting light with sufficient power to burn or genetically damage the ectoparasites onto a portion of the animal that includes at least one of the ectoparasites. Feature 11: Projecting the light onto the body of the animal comprises: projecting at least one of visible or non-visible light onto the body of the animal. Feature 12: Projecting the light onto the body of the animal comprises: projecting light substantially similar to 254 nanometer wavelength light. Feature 13: Actions include detecting, using a second captured image of the animal captured subsequent to the captured image of the animal, the animal; and projecting the light onto the body of the animal at a time after capturing the second captured image. Feature 14: Actions include determining, using stored values representing one or more previous light dosages of the animal, that a dosage of the animal is less than a threshold; in response to determining that the dosage of the animal is less than the threshold, projecting the light onto the body of the animal. Feature 15: Actions include determining, using stored values representing one or more previous light dosages of the animal, that a dosage of the animal satisfies a threshold; in response to determining that the dosage of the animal satisfies the threshold, projecting the light onto the body of the animal. Feature 16: Actions include detecting, using the second captured image of the animal, an ectoparasite or diseased tissue on the animal; and in response to detecting the ectoparasite or the diseased tissue on the animal, projecting the light onto the body of the animal. Feature 17: The animal is a fish.

The technology described in this specification can be implemented so as to realize one or more of the following advantages. For example, by configuring projection areas specifically for each detected animal, a more targeted mitigation approach can be achieved, which can reduce the changes of causing harm while improving the chances that treatment is successful. Lower dosages of light can be used by tracking animals over time to apply multiple dosages of light. The cumulative dosage can be sufficient to effectuate treatment while the lower instantaneous dosage can help prevent harm to the animal or surrounding animals. In some cases, light can be projected onto a predicted region for an animal. If an animal is not predicted to be within a threshold distance from a light projector, computation savings can be realized by skipping projection area configuration for that particular detection instant—e.g., an animal may move out of range thus dosing may continue when a system detects the animal will be within a range of a light projector at some point in the future.

In some cases, techniques described can enable distance-dependent treatment of animals. For example, a first type of treatment may be suitable when an animal is within a first range of distance from a treatment system. A second type of treatment, different than the first, may be suitable when an animal is within a second range. Different treatments can have different efficacies based on distance to an animal to be treated. For example, ultraviolet-C (UVC) can attenuate more than other forms of light, such as ultraviolet-A (UVA). In some cases, ultraviolet-C (UVC) can have greater germicidal effect compared to other forms of light, such as ultraviolet-A (UVA). In the case of aquaculture, a treatment system can determine a distance to an animal to be treated and, in response to determining the distance, select a type of light to be projected. For example, a form of treatment that is more effective over greater distances can be used at those greater distances and vice versa.

Dynamically selecting treatments based on animal proximity can allow a greater number of animals to be treated over a period of time because multiple treatments can be used that are suitable for more than one range of distances. Such dynamic treatments can improve efficacy for a given animal, e.g., by selecting a more effective treatment based on a proximity of the given animal at a treatment time. By improving efficacy, treatment outcomes for one or more animals can be improved.

In some cases, light can be projected onto an animal or environmental element and light reflected from that projected light can be used to inform a subsequent treatment, such as a subsequent light projection. For example, light within a visible or non-visible spectrum can be projected onto an animal. A camera of a treatment system can detect the projected light that is reflected off the animal. The camera can use the detected light to determine one or more subsequent treatments. In some cases, the system uses one or more machine learning models or other processes to determine one or more features of the detected light. In response to determining a first set of one or more features, a first treatment action can be performed. In response to determining a second set of one or more features, a second treatment action, different than the first, can be performed. For example, in response to the detected light being below an intensity threshold, a treatment system can use a non-light form of treatment.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an environment for light projection treatment.

FIG. 2 shows an example process of light projection.

FIG. 3 shows example detected areas from real-world images captured in an aquaculture environment.

FIG. 4 shows an example process for projecting light onto an animal.

Like reference numbers and designations in the various drawings indicate like elements.

### DETAILED DESCRIPTION

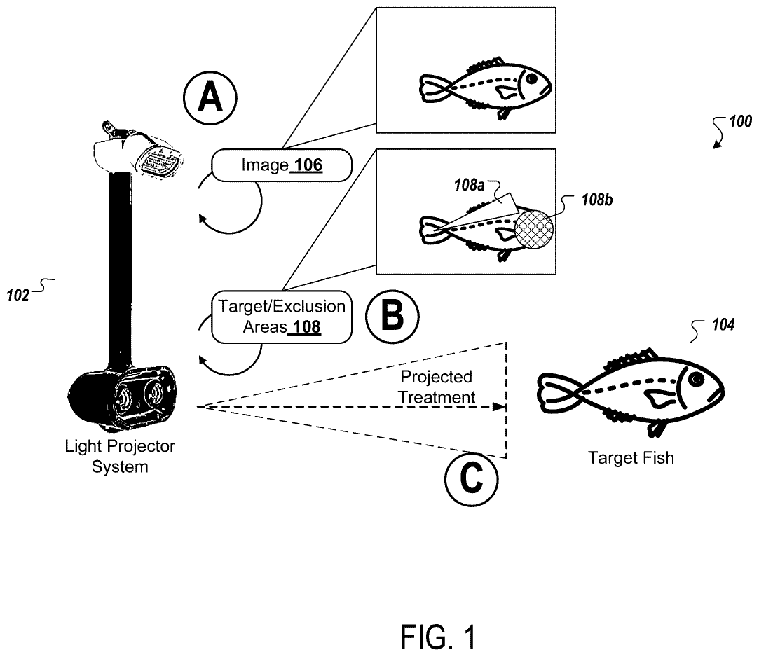

FIG. 1 shows an environment 100 for light projection treatment. The environment 100 includes a light projector system 102. The system 102 can be used to treat any animal although this description focuses on the example of fish. The system 102 includes one or more lights that can be configured to project light on particular areas of an animal, e.g., to treat the animal. In the example of FIG. 1, the system 102 is configured to be submersible and project light onto fish, such as the target fish 104. The light can be configured to illuminate portions of the fish 104 without illuminating other portions of the fish 104. The light can be powerful enough to treat one or more diseases.

In stage A, the light system 102 captures an image 106 of the fish 104. In stage B, the image 106 can be processed, using one or more computers—e.g., onboard the system 102 or communicably connected to the system 102—to determine where or when to project light onto the fish 104. Target/exclusion areas 108 can be detected using the determinations that includes, e.g., a target area 108a near a dorsal fin of the fish 104 and an exclusion area 108b near eyes or mouth of the fish 104. In stage C, the system 102 can use the target/exclusion areas 108 to project light for treating one or more diseases, such as parasites or other diseases. The projected light can include one or more frequencies of light.

In some cases, the system 102, using an onboard computer or a computer via a communication link, can detect the target/exclusion areas 108 using one or more trained machine learning vision models. For example, the one or more models can be trained to detect one or more specific targets, such as parasites, on an animal, such as a fish. The models can be trained using supervised or unsupervised learning processes. Ground truth data indicating known locations of specific targets can be used to adjust the one or more models—e.g., using one or more backpropagation processes.

In some cases, an animal can be cumulatively dosed. An animal can receive a first light treatment at a first time and a second light treatment at a second time. The system 102 can determine where or when to project light onto an animal. In some cases, markers can be used for tracking treatment for a given animal. Markers can include man-made and natural markers. Man-made markers can include tags fixed onto, or inside an animal—e.g., with a unique identifier, such as a radio frequency tag or visual tag. Natural markers can include characteristics of a skeleton, tissues, muscles, or other aspects of an animal's body.

Markers can be detected by one or more processes, including machine learning processes. For example, a machine learning model can be trained to detect an identifier affixed to an animal or one or more natural markers that exist on a given species of animal. The system 102 can detect markers and, using the detected markers, identify an animal. The system 102 can then determine one or more target or exclusion areas or project light if target or exclusion areas have already been determined for the given animal. The system 102 can store information about animals in memory to track a treatment of one or more animals over time.

An animal can be cumulatively dosed until an exposure threshold is reached. For example, the system 102 can project a first amount of light on an animal that may be below a threshold to achieve a desired effect, such as ablation of a parasite. The system 102 can project a second amount of light at a later time in response to detecting the same animal at that time. The second amount of light can be sufficient to achieve the desired effect. By separating dosages of projected light, lower powers of light can be used which can prevent damage to tissue or other aspects of animal welfare.

The system 102 can project one or more specific wavelengths, such as ultraviolet-C (UVC), near-infrared (NIR), visible light, or a combination of these. Light can be used for treatment, diagnosis, tracking, or a combination of these. In some cases, two or more specific wavelengths can be delivered simultaneously. Techniques described in this document can be applied in various treatments, e.g., treatments for (i) “Sea lice” mitigation (Caligidae) or (ii) wound sterilization or disease treatments (Germicidal or Cautery Effects). Techniques can be applied in salmon aquaculture.

In some cases, a significant reduction in parasite viability can be achieved with specific exposure times. Techniques described offer a targeted approach for treatment, such as disease or parasite mitigation, potentially reducing the drawbacks associated with existing treatment methods, e.g., which can pose additional harm to a targeted organism, surrounding organisms, or a surrounding environment.

Described techniques relates to the treatment of organisms, including the treatment of organisms used in aquaculture. Techniques include systems and methods for mitigating diseases and parasites in animals, including farmed aquatic organisms, utilizing optical projection technology with one or more light sources, e.g., a lamp, laser, light emitting diode (LED), or a combination of these, among others. Lights projected, e.g., by the system 102, can include ultraviolet (UV) wavelengths amongst others.

In some cases, an animal can be treated in-situ. For example, the fish 104 can be treated while swimming in an aquaculture pen. Treatment can include mitigation of parasites, such as sea lice, or other diseases, such as diseases affecting aquatic organisms, including farmed fish like salmon. The system 102 can include a digital light processing (DLP) projector, e.g., with a custom optical engine. The system 102 can be configured to deliver one or more bands of wavelengths of light onto targeted areas of an animal, such as a fish.

The system 102 can include one or more of the following components:
Custom Optical Engine Module: This module can include suitable optics and one or more light sources, such as ultraviolet (UV), near infrared (NIR), visible light, or a combination of these. The module can include a Digital Micromirror Device (DMD). The module can delivery specific spectral content for treatment and/or tracking.
DLP Driver: This component can include a DLP chipset. The component can include a controller and Power Management Integrated Circuit (PMIC)/LED driver. The component can be triggered for synchronized operation.
System Front End: This can include a receiver for input, USB Bridges, Universal Asynchronous Receiver-Transmitter (UART), or a combination of these, e.g., for communication and control.

A treatment process (such as a lice mitigation process) can include one or more of the following steps:
Acquire and Encode Video: Images of an environment, such as an aquatic environment that includes a target fish, such as the fish 104, can be captured and/or encoded.
Run Inference: An inference model, such as a fish detector or truss model, can be executed on one or more acquired images, e.g., to identify and locate one or more of fish or treatment areas. Treatment areas can include parasites or diseased areas. These areas can be included in the target/exclusion areas 108.
Mask the Head/Eye Area: The system can “mask” or exclude a head and/or eye area of an organism, such as a fish, from treatment projection, e.g., to minimize potential harm.

In some cases, masking can be performed as part of configuring a projection area to allow light onto one or more target areas and preventing light from projecting onto one or more exclusion areas. Channel content for a projected image can be encoded as desired.

Project Images: Digitally or optically corrected multispectral images, including a desired UV dosage, can be projected back onto the target organism (e.g., the fish 104), treating specific areas. A custom optical engine and DLP technology can enable precise spatial and/or temporal control of the projected light. Providing multispectral content—e.g., NIR, UV, or a combination of these among others—can depend on an optical engine being used.

Use Markers to Track Trajectories and Success: Markers can be used to track movement of an organism (e.g., a fish) and/or success of a treatment over time. Efficiency of application of the treatment can be evaluated via these markers, e.g., as a feedback loop. In some cases, feedback can be used to adjust one or more other processes or as a part of a model training process.
Repeat as Needed: The process can be repeated, e.g., to cumulatively dose the parasites or diseased areas to reach a desired exposure threshold for mitigation.

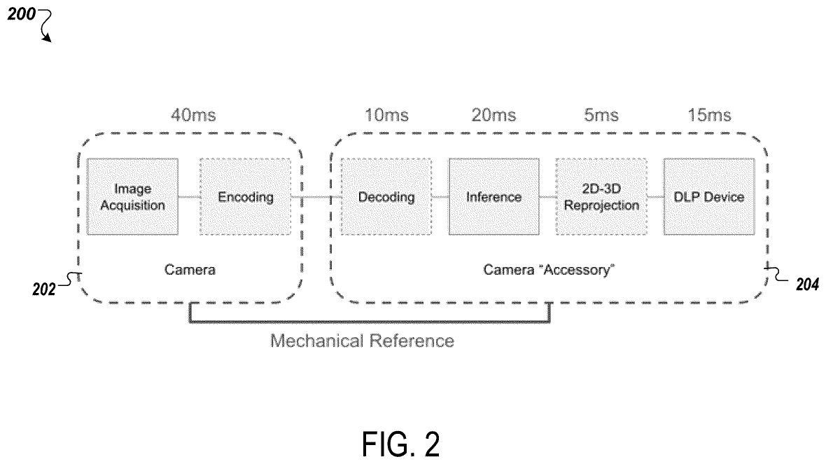

FIG. 2 shows an example process 200 of light projection. Example time estimates for various processes are shown. Of course, processes can be completed in any suitable amount of time. A camera 202 can acquire an image and encode the image for processing. The camera 202 can be a component of the system 102 or communicably attached to the system 102. The camera 202 provides encoded image data to a camera accessory 204. The accessory 204 can include one or more computers, such as the one or more computers onboard the system 102 or communicably connected to the system 102. The accessory 204 can decode and perform one or more inference processes on the decoded data—e.g., to detect one or more areas for light projection on the animal. The accessory 204 can generate a two-dimensional-three-dimensional (2D-3D) reprojection using data generated from the one or more inference processes. The accessory 204 can generate an instruction for a projecting device, e.g., to project light onto the fish 104 using the generated 2D-3D reprojection.

In some cases, 2D-3D reprojection can use a generated 3D model. For example, the system 102 can generate a 3D model of a scene or an object within a scene, such as the fish 104. The system 102 can include sensors, such as a mono or stereo camera or other sensor. Input from the sensors can be used to generate a 3D model. In some cases, the system 102 includes one or more truss models. The truss models can generate one or more 3D structures using data from one or more sensors of the system 102. The truss models can generate one or more trusses that represent a shape of one or more structures. Trusses can include distances, within a 2D or 3D space, from a first point to a second point.

In some cases, 2D-3D reprojection flattens an area from a generated 3D model into 2D. Areas determined for treatment can be determined within the 2D projection of the generated 3D model. The 3D model can provide information corresponding to a position of an animal, such as at least one of distance, angle, or orientation. Information corresponding to a position of an animal can be used to detect one or more target areas for treatment, e.g., by providing data indicating the information to one or more trained machine learning models or other processes.

In some cases, the system 102 performs a distortion correction. For example, light going from one material to another, such as air to water, can be refracted due to a change in refractive index. The system 102 can uses one or more sensors to detect a type of material within an environment. The system 102 can maintain data indicating one or more known materials—materials within its own system or an environment. The system 102 can use at least one of a detected material type of a known material type to determine a refraction of light to be projected onto an animal. Using the determined refraction, the system 102 can adjust a projection area to help the projected light hit its target.

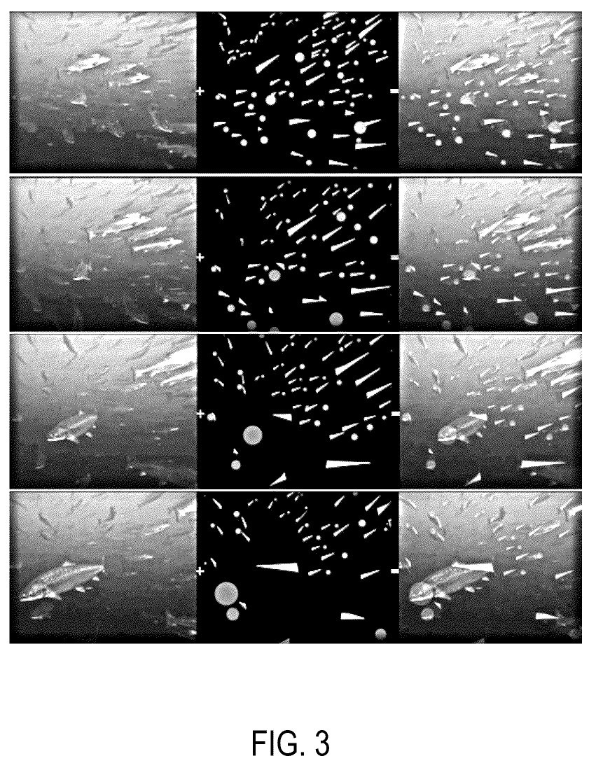

FIG. 3 shows example detected areas from real-world images captured in an aquaculture environment. Triangles represent target areas and circles represent exclusion areas. Time increases from top row to bottom row. The first column shows raw images. The second column shows detected areas. The third column shows detected areas mapped onto animals, in this case, fish. A system need not actually generate visual representation of areas or images. For example, a system can merely generate data that are at least somewhat representative of such areas and use that data for relevant processes.

Note that the example regions detected can be changed depending on implementation. For example, target areas can include a dorsal fin area but need not include such areas. Similarly, exclusion areas include eyes and mouths of fish but other animals, or species of a given animal, may have other sensitive areas. In general, exclusion areas can include any area that may be potentially harmed by projected light. Target areas can include any area that can be healed or otherwise treated by projected light.

### UV Light for Lice and Disease Mitigation

UVC light at 254 nm can degrade the DNA of lice eggs and adult lice, and has beneficial effects on infections in trout (germicidal). A total dose of 0.09 J/cm² of UVC light at 254 nm can result in a 95% reduction in copepodid production from sea lice eggs. A 99% reduction in copepodid production can be achieved by exposing salmon with adult lice to approximately 0.1 J/cm² of UVC light over a 6-day period.

### Dosage Calculations (Example) It is possible to show calculations for organism disease treatment using DLP projection—e.g., considering a specific case of Atlantic salmon.

Assuming a 600 lumen output from the custom optical engine projected over an approximate salmon surface area of 0.31m², the following calculations provide an estimated dosage according to some implementations:
Lumens to Lux: 600 lm/0.3 m^{2≈1935} lx.
Lux to Watts per Square Meter: 1935 lux/200 lm/W≈9.675 W/m² (assuming a luminous efficacy of 200 lm/W).
Watts per Square Meter to Joules per Square Meter: J/m²=9.675 W/m²×Time (in seconds).
Joules per Square Meter to Joules per Square Centimeter: J/cm²=J/m²/10,000 cm²/m².

With an exposure time of 100 seconds, this can result in approximately 0.097J/cm². It is noted that this result can be dependent on luminous efficacy, which might be lower in reality.

Systems described can include DLP technology, which can include a DMD chip with microscopic mirrors. The mirrors can be individually controlled to project light patterns. A DLP driver can control the DMD and one or more light sources (e.g., UV LEDs). This allows for precise control over the spatial distribution and intensity of the projected light, enabling targeted treatment. In some cases, the system 102 can include DLP technology, e.g., as part of one or more light projectors.

Techniques can include various elements or processes configured to address one or more of the following:
Raw Efficiency of DMD devices in the UVC range: The efficiency of DMDs in the germicidal UVC range might be lower compared to other wavelengths. In some cases, higher instantaneous power can be increased by varying a duty cycle. Increasing power can help increase efficacy of a light treatment or extend a range of a light treatment. In some cases, higher instantaneous power can be achieved by adjusting a duty cycle to be off, as opposed to on, for a greater period of time.
Attenuation and scattering effects (especially UVC) in seawater: Water absorbs and scatters UV light, which can affect the effective treatment distance and dosage. In some cases, UVA light can be used. UVA can disperse less than other forms of light in seawater. In some cases, the form of light used can vary depending on a type of environment in which the animal treatment occurs. In some cases, the system 102 can detect the type of environment, using one or more sensors. In some cases, the system 102 can receive, or maintain data, that indicates one or more types of environment that the system 102, has, is, or will be operating in.
Efficacy and ground truth of treatment: The optimal UV dosages and exposure regimes for effective parasite mitigation while minimizing harm to the fish.
System latency: Accurate targeting of moving fish, e.g., by minimizing the time delay between image acquisition and projection. In some cases, latency can be reduced by implementing at least one of the following: utilizing low latency local protocols, centralizing compute, or using lower latency network protocols. In some cases, a hybrid compute topology can be utilized, e.g., by the system 102.
Projection Correction Underwater: Correcting projected light using input indicating optical properties of water which can distort projected images.
Packaging: A robust and reliable underwater system for deployment in aquaculture environments.
Techniques can include combining image analysis, targeted projection, and/or controlled UV dosage to improve treatment of organisms, such as fish in aquaculture or animals in agriculture. Treatment can be improved at least in part by localizing treatment to reduce harmful effects to the targeted organism, other organisms, or a surrounding environment.

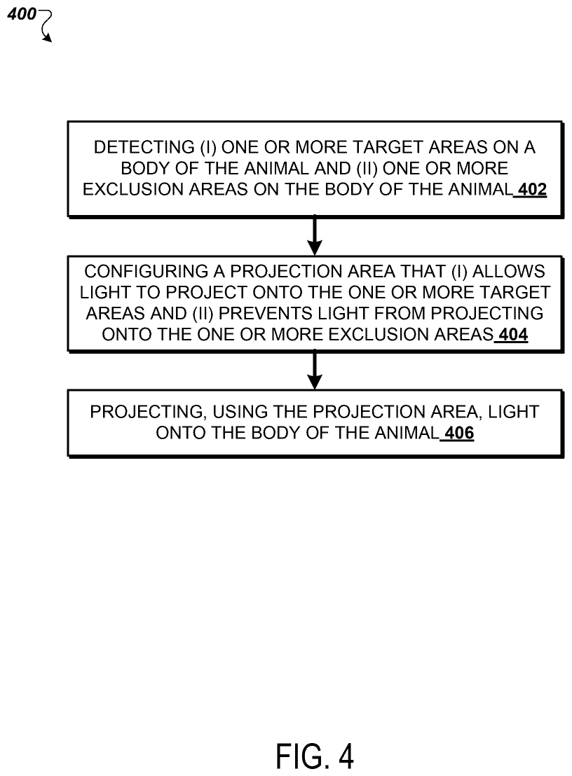

FIG. 4 shows an example process 400 for projecting light onto an animal. The process 400 can be performed by a system that includes one or more computers, located in one or more locations, and programmed appropriately in accordance with this specification. For example, the system 102 of FIG. 1, appropriately programmed, can perform the process 400.

The process 400 includes detecting (i) one or more target areas on a body of the animal and (ii) one or more exclusion areas on the body of the animal (402). For example, the system 102 can use a captured image of an animal, such as the fish 104, to detect the target/exclusion areas 108. The system 102 can use one or more computers to detect parasites or other elements of interest and detect a target area as an area that includes the one or more elements of interest.

The process 400 includes configuring a projection area that (i) allows light to project onto the one or more target areas and (ii) prevents light from projecting onto the one or more exclusion areas (404). For example, the system 102 can configure a projection area using one or more mechanical elements or software instructions. In some cases, the system 102 generates an instruction to one or more elements of a DLP system, which can be included in the system 102, configured to cause the elements to project light onto particular areas but not onto other areas—e.g., onto the target area 108a but not onto the exclusion area 108b. In some cases, the system 102 controls mechanical masking elements to physically prevent light from projecting onto a portion of the target fish 104. For example, a shutter or other opaque element can be used to block or redirect light from the system 102 such that the light does not project onto an exclusion area.

In some cases, the projection area can include multiple points—e.g., x/y or x/y/z points. For example, considering a surface of an animal as a plane or a three-dimensional surface, each point can be represented with two or three values representing coordinates in a given system, such as cartesian coordinates. The projection area can include multiple coordinate points such that the projection area extends over a region of the animal rather than a single point in space. By dispersing the light over a region, rather than a single point, dosage intensity can be reduced. Reducing dosage intensity can reduce harmful effects on animals on which light is projected.

In some cases, projection intensity can vary within a target area. For example, a sub-region of a target area can require a first amount of light while another region of the target area can require a second amount of light. The system 102 can configure the projection area to provide a variable intensity across the target area to account for differences within the region. This can help increase the efficacy of treating the given target area. Variable intensity over an area can improve at least one of digital micromirror device (DMD) efficiency or treatment efficacy.

In some cases, the projection area can be configured to help minimize harm—e.g., avoid sensitive areas that can be damaged by projected light. For example, certain regions of an animal may be sensitive to light exposure. On fish, these regions can include the eyes or the head region. The system 102 can configure light to project onto regions other than regions that are sensitive to light exposure. The projected onto regions can include one or more detected features, such as detected ectoparasites or diseased tissue.

In some cases, configuring a projection area can include determining one or more points and providing the one or more points to a light projector. For example, the system 102 can include one or more computers and a light projector. The light projector can be configured to receive data indicating a region from the one or more computers. The data indicating a region can include a projection area. The light projector can use the received data to project light onto an animal, such as the fish 104.

In some cases, the system 102 can determine a time to project light onto a body of an animal. The time can be some time in the future. The system 102 can the project light onto the body at that future time. For example, the system 102 may detect an animal, such as the fish 104, at a first point in time. Projecting light at the first point in time may not be feasible or optimal—e.g., the fish 104 might not be within a threshold distance from a suitable light projector, of one or more projectors, or may have too recently received a prior dose. Environmental factors may indicate that light projection should wait for a period of time. Environmental factors can include a visual separation between a light projector an animal—e.g., caused by fog, dust, debris or organisms in water, among others. Visual separation can depend on factors such as recent weather, feeding schedules, algae production in the area, among others. Environmental factors can include an available power of a projector—e.g., which may increase during peak sunlight hours and decrease during non-peak sunlight hours. The system 102 may determine to wait until sufficient power is available. Factors can include scheduled events, such as feeding, weighing, milking, harvesting, among other operations. The system 102 may determine to wait until no other conflicting operation is occurring before projecting light.

In some cases, the system 102 can determine at least one of a place, or position of an animal, to project light onto a body of an animal. For example, one or more light projectors can be included in the system 102. The system 102 can determine which of the light projectors to use for a given animal projection. The light projectors can be located at different positions. The system 102 can determine a position of the animal as a requirement for projection. For example, the system 102 can determine to project light onto an animal when the animal has a particular orientation or distance from a light projector—e.g., angled X degrees from a normal vector of the light projector and a distance of Y meters, where X and Y can be any value.

In some cases, a more side-on view of an animal can help improve accuracy of a projected region. For example, if the fish 104 is angled with its head towards a light projector of the system 102, the chances of an inadvertent ray of light projecting onto a portion of an exclusion area might increase compared to if the head was more side-on to the light projector. In some cases, the system 102 can wait for an animal to present a broader view of itself prior to projecting the light—e.g., to help ensure that light projection does not harm the animal by straying from a determined target area.

In some cases, the system 102 includes one or more machine learning models configured to determine aspects of projecting light onto an animal. For example, the models can be trained using one or more factors, such as time of day, events at a location, prior detections, prior light projections, prior harvest data, likelihood of harm to the animal or nearby animal, proximity to light projector, water or air clarity, animal type, speed of animal, operation schedule, among others. Training samples indicating ideal or near-ideal projection regions can be provided during a training stage. The samples can include a determined time or location for projecting light onto an animal. The models can learn an ideal, or near-ideal, mapping of the one or more factors to light projection. Output of the models can include data indicating at least one of a projection area, a time for projecting light, and a location of a light projector or animal required for projecting the light.

In some cases, the system 102 can determine one or more control signals to move a light projector to another location prior to projecting light onto an animal. For example, the system 102 can be configured to send signals to one or more winches configured to move the system 102 or one or more connected light projectors. Methods of moving can be altered for a suitable environment. For example, wheel-based movement can be used for land-going systems. Jets or propellers can be used for air or water going systems. Winches can be used for land, water, or air-based systems.

In some cases, one or more treatments can be more effective in some areas than in others. For example, treatment with light can be more effective in areas that offer greater transmission of light. Transmission of light can be reduced by environmental factors, such as environmental currents, weather, animal waste, or a combination of these. The system 102 can detect, or receive data indicating, a state of an environment. Using the state, the system 102 can determine one or more control signals to move to a position within a space, such as a position that offers greater transmission of light. In an underwater implementation for treating fish or other water-based animals, transmission might improve, in general, at shallower depths compared to deeper depths. Environmental factors can effect general trends with regard to transmission efficacy.

In some cases, the system 102 can predict a future location of an animal. For example, using a captured image, the system 102 can predict an animal will move a particular amount and be at another position at some future time. The future position can include an orientation of the animal at that future time. The system 102 can configure a projection area to account for that movement, e.g., by translating one or more detected areas to areas for projection. If an animal changes angles, detection areas may increase or decrease. If a predicted position is not within range or an orientation does not satisfy required orientation thresholds, the system 102 can skip projection area determination—e.g., to reduce computational expenditure for non-projection event.

The process 400 includes projecting, using the projection area, light onto the body of the animal (406). For example, the system 102 can project light onto the fish 104 using at least one of the target/exclusion areas 108. Projecting can include providing one or more control signals configured to control one or more light projectors to project light onto an animal.

The projected light can include any suitable wavelength of light and may extend over a region of interest—such as a region including one or more ectoparasites or diseased tissue. In some cases, light can be used for non-diseased fish—e.g., as a preventative measure for developing disease or to otherwise improve animal welfare, such as by stimulating one or more biological processes.

In some cases, the system 102 delays light projection. For example, the system 102 can determine one or more areas on an animal. The system 102 can store the one or more areas for the particular animal in memory. The system 102 can wait for an opportune moment to project light on the given animal—e.g., by detecting the animal using one or more fish identification processes based on machine vision and querying a stored set of areas at a time subsequent to taking an initial image and determining one or more target or exclusion areas.

An opportune moment can be determined by the system 102, e.g., using one or more trained machine learning models. The models can receive one or more environmental factors indicating a likelihood of an optimal result for projecting light. If the factors for a given detection of an animal satisfies one or more thresholds, the system 102 can determine that projection of light should occur. The system 102 can then generate a signal instructing a light projector of the system 102 to project light onto an animal that is currently within a light projecting distance. That animal may have been previously detected by the system 102 and the system 102 can use target/exclusion areas determined from the previous detection to generate the latter light projection. In some cases, the system 102 can check a time corresponding to a saved set of areas to determine if the detection is stale—e.g., areas for treatment may have changed after a day or week. The system 102 might only project light for a subsequent detection of an animal for treatment if the system 102 determines that the prior detection is within a threshold time from the subsequent detection.

Light projection can be used for sea lice mitigation or other treatment, such as burning or cauterizing. Light can be projected in one or more different modes. For example, modes of a system can include a genetic harming mode—e.g., for damaging DNA of a parasite attached to an animal without killing the parasite. Modes can include an ablation mode—e.g., where light is projected with sufficient power to kill a parasite or other remove diseased tissue from an animal. Light can be projected in visible or other wavelengths, such as ultraviolet, infrared, near-infrared, or a combination of these, among others. In some cases, light projection can include wavelength substantially similar to, or matching, 254 nanometers. Light substantially similar to, or matching, this wavelength can help degrade the DNA of lice eggs and adult lice—e.g., to reduce ectoparasite infections on one or more animals, such as salmon.

In some cases, an animal can be tracked over time. Light can then be projected onto the animal over time to achieve a given dosage. Animals can be tracked to determine if a dosage is sufficient, e.g., to reduce or eliminate a known issue or achieve a biological improvement. In some cases, the system 102 can determine a dosage for an animal and project light onto the animal, each time the system 102 detects the animal within a threshold distance or in a suitable position or orientation for light projection, until the determined dosage is met. In some cases, the system 102 can check, prior to dosing an animal, whether or not additional doses are required—e.g., to achieve a biological improvement. If additional doses are not required based on an instant detection, even if contrary to prior determined dosage amounts, the system 102 can withhold light projection for the given animal and remove the animal from a list of animals for which dosing is ongoing.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The subject matter and the actions and operations described in this specification can be implemented in digital electronic circuitry, in tangibly-embodied computer software or firmware, in computer hardware, including the structures disclosed in this specification and their structural equivalents, or in combinations of one or more of them. The subject matter and the actions and operations described in this specification can be implemented as or in one or more computer programs, e.g., one or more modules of computer program instructions, encoded on a computer program carrier, for execution by, or to control the operation of, data processing apparatus. The carrier can be a tangible non-transitory computer storage medium. Alternatively or in addition, the carrier can be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit. Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, the subject matter described in this specification can be implemented on one or more computers having, or configured to communicate with, a display device, e.g., a LCD (liquid crystal display) monitor, or a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech, or tactile feedback or responses; and input from the user can be received in any form, including acoustic, speech, tactile, or eye tracking input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

The subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this by itself should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method comprising:
detecting, using a captured image of an animal, (i) one or more target areas that are occupied by one or more tracked ectoparasites on a body of the animal and (ii) one or more exclusion areas on the body of the animal;
generating a mask based on the detected one or more target areas that are occupied by the one or more tracked ectoparasites that (i) allows light to project onto the one or more target areas and (ii) prevents light from projecting onto the one or more exclusion areas; and
projecting, using the mask, light onto the body of the animal.

2. The method of claim 1, wherein the mask comprises multiple points in two-or three-dimensional space.

3. The method of claim 1, wherein detecting the one or more exclusion areas on the body of the animal comprises:
detecting a first exclusion area on the body of the animal, wherein generating the mask comprises:
configuring a second exclusion area of the mask that extends extend beyond the detected first exclusion area on the body of the animal.

4. The method of claim 1, wherein the one or more exclusion areas include a head or eye area of the animal.

5. The method of claim 1, comprising:
determining at least one of (i) a time or (ii) relative position of the animal for projecting the light onto the body of the animal;
determining at least one of (i) the time or (ii) the relative position of the animal is satisfied; and
in response to determining at least one of (i) the time or (ii) the relative position of the animal is satisfied, projecting the light onto the body of the animal.

6. The method of claim 5, comprising:
providing data indicating an environment of the animal to one or more machine learning models; and
receiving output of the one or more machine learning models as at least one of (i) the time or (ii) the relative position of the animal for projecting the light onto the body of the animal.

7. The method of claim 6, wherein providing the data indicating the environment of the animal to the one or more machine learning models comprises data indicating at least one of: (i) time of day, (ii) operation schedule, (iii) visual clarity of the environment, (iv) proximity to light projector, (v) size of animal, (vi) speed of animal, and (vii) animal type.

8. The method of claim 1, comprising:
generating a control signal to move a light projector to a position; and
projecting the light onto the body of the animal after reaching the position.

9. The method of claim 1, wherein generating the mask comprises:
predicting a future location of the animal using at least the captured image of the animal; and
translating at least one of the detected target areas and the exclusion areas using the predicted future location, wherein projecting the light onto the body of the animal comprises projecting the light using the translated areas based on the predicted future location.

10. The method of claim 1, comprising:
generating the mask for a predicted location of the animal at a future point in time;
waiting a period of time until the future point in time; and
projecting the light onto the body of the animal at the future point in time.

11. The method of claim 1, wherein projecting the light onto the body of the animal comprises:
projecting light with sufficient power to burn or genetically damage the one or more tracked ectoparasites..

12. The method of claim 1, wherein projecting the light onto the body of the animal comprises:
projecting at least one of visible or non-visible light onto the body of the animal.

13. The method of claim 1, wherein projecting the light onto the body of the animal comprises:
projecting light with a wavelength configured to harm a parasite of the animal.

14. (canceled)

15. The method of claim 1, comprising:
determining, using stored values representing one or more previous light dosages of the animal, that a dosage of the animal is less than a threshold; and
in response to determining that the dosage of the animal is less than the threshold, projecting the light onto the body of the animal.

16. The method of claim 1, comprising:
determining, using stored values representing one or more previous light dosages of the animal, that a dosage of the animal satisfies a threshold; and
in response to determining that the dosage of the animal satisfies the threshold, preventing projection of light onto the body of the animal.

17. The method of claim 1, comprising:
detecting, using the captured image of the animal, an ectoparasite or diseased tissue on the animal; and
in response to detecting the ectoparasite or the diseased tissue on the animal, projecting the light onto the body of the animal.

18. The method of claim 1, wherein the animal is a fish.

19. One or more non-transitory computer storage media encoded with computer program instructions that when executed by one or more computers cause the one or more computers to perform operations comprising
detecting, using a captured image of an animal, (i) one or more target areas that are occupied by one or more tracked ectoparasites on a body of the animal and (ii) one or more exclusion areas on the body of the animal;
generating a mask based on the detected one or more target areas that are occupied by the one or more tracked ectoparasites that (i) allows light to project onto the one or more target areas and (ii) prevents light from projecting onto the one or more exclusion areas; and
projecting, using the mask, light onto the body of the animal.

20. A system comprising:
one or more computers and one or more storage devices on which are stored instructions that are operable, when executed by the one or more computers, to cause the one or more computers to perform operations comprising:
detecting, using a captured image of an animal, (i) one or more target areas that are occupied by one or more tracked ectoparasites on a body of the animal and (ii) one or more exclusion areas on the body of the animal;
generating a mask based on the detected one or more target areas that are occupied by the one or more tracked ectoparasites that (i) allows light to project onto the one or more target areas and (ii) prevents light from projecting onto the one or more exclusion areas; and
projecting, using the mask, light onto the body of the animal.

21. The method of claim 1, wherein the detecting, the generating, and the projecting are repeated over time to cumulatively dose the one or more tracked ectoparasites to reach an exposure threshold.
